(19) United States
(12) Patent Application Publication
(10) Pub. No.: US 2021/0331187 A1
(43) Pub. Date: Oct. 28, 2021

(54) MODULAR ADAPTIVE MISTING SYSTEM ATTACHMENT TO HIGH CFM ELECTRIC BLOWER AND ELECTRIC/BATTERY OPERATED BACKPACK SPRAYER

(71) Applicants: Chad Youngblut, Mount Dora, FL (US); William Boatwright, Leesburg, FL (US)

(72) Inventors: Chad Youngblut, Mount Dora, FL (US); William Boatwright, Leesburg, FL (US)

(21) Appl. No.: 16/990,616

(22) Filed: Aug. 11, 2020

Related U.S. Application Data
(60) Provisional application No. 63/014,017, filed on Apr. 22, 2020.

(51) Int. Cl. B05B 7/24; A01M 7/00

(52) U.S. Cl. CPC B05B 7/2475; A01M 7/0021; B05B 7/2424; B05B 7/2416

(57) ABSTRACT

An adapter system for transforming an electric backpack into a sprayer for pesticides and disinfectants is disclosed, the adapter system comprising a reservoir in fluid communication with a sprayer, the reservoir to retain a liquid. One or more supply lines deliver the liquid to the sprayer having a blower with a handle portion including a first side to receive a conduit in fluid communication with a nozzle adapter and a nozzle to emit a mist therefrom. A power supply is in electrical communication with the blower to supply power thereto to provide a portable sprayer system.

### CROSS-REFERENCE TO RELATED APPLICATIONS

The present application claims priority to U.S. Provisional Patent Application 63/014,017 filed on Apr. 22, 2020, entitled “BATTERY-OPERATED MISTER” the entire disclosure of which is incorporated by reference herein.

### TECHNICAL FIELD

The embodiments generally relate to blower attachments, pesticide applicators, and accessories thereof.

### BACKGROUND

Sprayers are devices used to spray a liquid, such as water, weed killers, crop performance materials, pest maintenance chemicals, as well as manufacturing and production line ingredients. Specifically, in agriculture, sprayers are equipment for the dispersal of herbicides, pesticides, and fertilizers onto crops. These devices range in size from handheld portable units (often backpacks with spray guns), to trailed sprayers that are connected to a tractor, to self-propelled systems with boom mounts to disperse the liquid spray over a large area.

While many of the aforementioned systems are portable, these systems include a wired connection to a power source and liquid reservoir to store the liquid, which is driven through the blower. This is inconvenient for the operator and does not allow for modularity of the system.

Recently, concern over the spread of pathogens has resulted in businesses regularly sanitizing surfaces after use. For example, hotels are manually sanitizing surfaces using liquid or aerosol sprays and wiping down surfaces by hand. This process can be time consuming and expensive for businesses dealing with new expectations from customers and government regulations.

### SUMMARY OF THE INVENTION

This summary is provided to introduce a variety of concepts in a simplified form that is further disclosed in the detailed description of the embodiments. This summary is not intended to identify key or essential inventive concepts of the claimed subject matter, nor is it intended for determining the scope of the claimed subject matter.

The embodiments described herein provide a portable sprayer assembly for pesticides and disinfectants, the assembly comprising a reservoir in fluid communication with a sprayer and wherein the reservoir is configured to retain a liquid. One or more supply lines deliver the liquid to the sprayer, having a blower with a handle portion including a first side to receive a conduit in fluid communication with a nozzle adapter and a nozzle to emit a mist therefrom. A power supply is in electrical communication with the blower to supply power thereto, providing a portable sprayer system.

The embodiments provide a modular sprayer system that is readily portable to allow the user to apply a disinfectant or pesticide to the environment. The system can be easily assembled and deconstructed for storage. The modular nozzle adapter, nozzle, and atomizer allow the user to select an appropriate configuration of each for a particular application. The power supply is connected to the handle portion and may be carried by the user without a power cable connected to a remote power supply.

In one aspect, the nozzle adapter is releasably engaged with the handle portion via a conduit.

In one aspect, the nozzle adapter comprises a first adapter end fittingly engaged with the conduit and a second adapter end fittingly engaged with the nozzle.

In one aspect, the nozzle adapter includes a receiver having a channel to attach to the conduit.

In one aspect, the receiver is comprised of a locking mechanism to secure the receiver to the conduit.

In one aspect, the reservoir is configured as a backpack having at least two shoulder straps.

In one aspect, a bend is positioned along the length of the nozzle adapter.

In one aspect, an ON/OFF valve is positioned in fluid communication with the supply line.

In one aspect, the supply line comprises a quick disconnect coupler to attach the supply line to the nozzle adapter.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a top perspective view of the battery-operated mister attached to a blower, according to some embodiments;

FIG. 2 illustrates a schematic view of the airflow through the system, according to some embodiments;

FIG. 3 illustrates a schematic view of the airflow through an adjustable nozzle, according to some embodiments;

FIG. 4 illustrates a top perspective view of the second adapter end of the nozzle adapter, according to some embodiments;

FIG. 5 illustrates a top perspective view of the second adapter end of the nozzle adapter, according to some embodiments;

FIG. 6 illustrates a top perspective view of the first adapter end of the nozzle adapter, according to some embodiments;

FIG. 7 illustrates a top view of the nozzle adapter, according to some embodiments;

FIG. 8 illustrates a bottom view of the nozzle adapter, according to some embodiments;

FIG. 9 illustrates a front view of the first adapter end of the nozzle adapter, according to some embodiments;

FIG. 10 illustrates a vertical cross-sectional view of the inner structure of the nozzle adapter;

FIG. 11 illustrates a cutaway view of the adapter system for transforming an electric backpack blower into a sprayer, according to some embodiments;

FIG. 12 illustrates a perspective view of the adapter system, according to some embodiments;

FIG. 13 illustrates a perspective view of the adapter system, according to some embodiments; and

FIG. 14 illustrates a perspective view of the adapter system, according to some embodiments.

### DETAILED DESCRIPTION

The specific details of the single embodiment or variety of embodiments described herein are to the described apparatus. Any specific details of the embodiments are used for demonstration purposes only, and no unnecessary limitations or inferences are to be understood therefrom.

Before describing in detail exemplary embodiments, it is noted that the embodiments reside primarily in combinations of components and procedures related to the apparatus. Accordingly, the apparatus components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

The specific details of the single embodiment or variety of embodiments described herein are set forth in this application. Any specific details of the embodiments are used for demonstration purposes only, and no unnecessary limitation or inferences are to be understood therefrom. Furthermore, as used herein, relational terms, such as “first” and “second,” “top” and “bottom,” and the like, may be used solely to distinguish one entity or element from another entity or element without necessarily requiring or implying any physical or logical relationship, or order between such entities or elements.

As used herein, the terms “mister” and “sprayer” may be used interchangeably to discuss the embodiments. The mister/sprayer performs the functions of receiving a liquid and air mixture to generate a mist/spray from a nozzle and apply the liquid to an area. The area may be large, such as a landscape or other outdoor area as well as applicable in smaller enclosed areas such as a room, building, etc. The term “blower” is used to describe the element of the mister or sprayer that generates airflow and drives the liquid/air mixture through the components of the mister/sprayer and through the nozzle thereof.

In general, the embodiments provide a battery-operated mister, which can be provided as an adapter or as a whole unit that can include a leaf blower/mister adapter to dispense pesticides, disinfectants, deodorizers, and other processes that require atomization utilizing existing devices. The embodiments can be retrofit to most existing electric and manual backpack sprayers.

In some embodiments, the sprayer is provided with a manual pump backpack. The adapter may include an air scoop that catches the forced air from an electric leaf blower and directs the airflow into the top of the backpack tank. In such, the air scoop is an optional component which may be utilized with a manually powered (non-electric) sprayer. This creates positive pressure directing fluid from the tank out through the supplied quick-connect attachment to the adjustable sprayer adapter, which guides the fluid to the front of the battery-operated blower for dispensing. The air/fluid mixture is then turned into a mist through the nozzle. Thus, the user can use the same backpack for conventional spraying and misting throughout the whole operation as the system is readily switchable as desired. The mist flow rate may be adjustable depending on the application.

In some embodiments, the nozzle can be adjusted to angle up, down, or about 30° side-to-side to dispense the atomized fluid in the desired direction. One skilled in the arts will readily understand that the angle from side-to-side may be adjusted based on user requirements for various applications and may be considerable more or less than 30°. The sprayer can be angled up to treat under the leaves for mosquitos, angled down for treating turf for fleas, or angled to the side to treat a row of bushes. The embodiments enable professional technicians to offer same-day mosquito treatments without the need to return with large conventional stand-alone mister. Additionally, the nozzle of the present invention has an adjustable flow rate.

The embodiments include a battery-operated mister which can be provided as an adapter or as a whole unit that can include a leaf blower/mister adapter combo to dispense pesticides, disinfectants, deodorizers, and other processes that require atomization utilizing existing devices.

The embodiments provided herein replace the need for a stand-alone device (i.e., two different tanks, a gas blower, etc.). The sprayer allows operators to go from using a backpack to treat foundations for rapidly misting for pests, and then switch back as desired. The embodiments provide additional benefits such as producing no emissions, no gas fumes and no smells, which makes the sprayer suitable to be used indoors. The system is configured to be light (i.e., portable) and sufficiently maintenance-free.

The embodiments provide a battery-operated mister adapter. The battery-operated mister adapter enables users to turn an existing device such as a backpack pesticide sprayer and an electric blower to a battery-operated mister. In some embodiments, a quick-connect attachment, a nozzle adapter, an adjustable nozzle, at least one valve, and a quick-connect harness are provided. The quick-connect attachment facilitates the connection of the adjustable nozzle to a reservoir, preferably corresponding to a backpack pesticide sprayer. The nozzle adapter facilitates the connection of the adjustable nozzle to the blower. At least one valve enables the control of the flow of fluids from the reservoir to the adjustable nozzle. The quick-connect harness tethers the present invention to the reservoir to free up the hands of the user. The present embodiments can be provided as separate components which can be retrofitted to existing structures or as a whole unit.

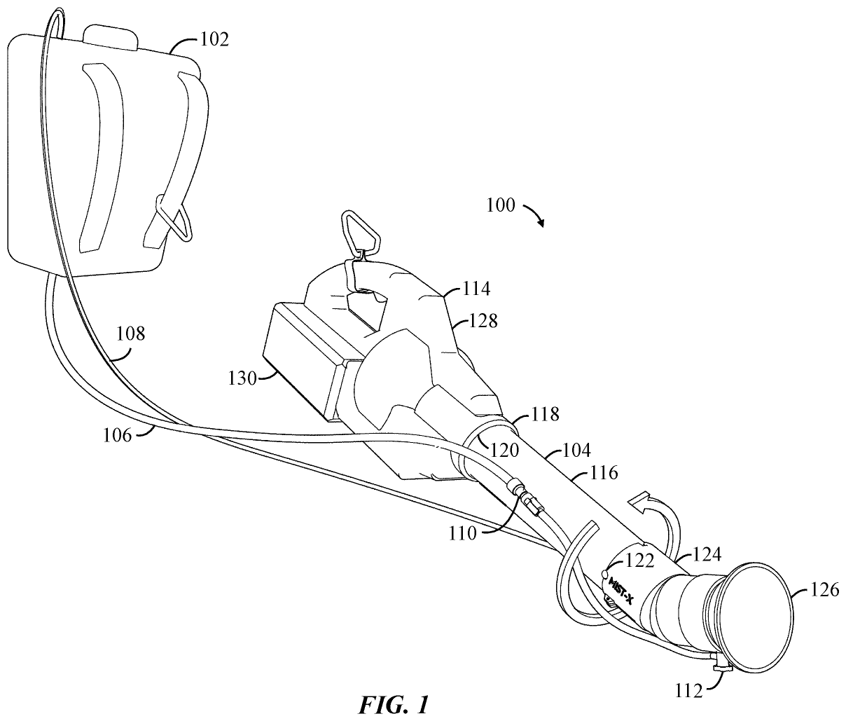

The aforementioned components enable the user to turn an existing backpack pesticide sprayer to a battery-operated mister. As can be seen in FIGS. 1-3, the nozzle adapter allows users to utilize an existing device, such as a leaf blower, to dispense fluids like a pesticide in an atomized form. The nozzle adapter is preferably designed to fit on the outlet of the blower and enables users to orient the adjustable nozzle in the desired direction. In the preferred embodiment, the nozzle adapter comprises an adapter body, a first adapter end, a second adapter end, and an air scoop.

FIG. 1 illustrates the system 100 including a reservoir 102, which may be configured as a wearable device such as a backpack. The reservoir 102 contains the liquid, which is supplied to the battery-operated sprayer 104 via supply line 106. A positive pressure line 108 may be in fluid communication with the reservoir 102 to supply positive pressure thereto to actively pump liquid from within the reservoir 102. The supply line 106 may be provided with a quick disconnect 110 to releasably attach to the sprayer 104. A flow rate adjuster 112 may be provided in fluid communication with the supply line 106 to adjust the rate at which liquid and/or air is provided to the sprayer 104. The sprayer 104 comprises a handle portion 114 and conduit 116 extending from a first side 118 of the handle portion 114. The conduit 116 includes first and second ends 120, 122. The conduit first end 120 attaches to the handle portion first side 118 while the conduit second end 122 attaches to a nozzle adapter 124. The nozzle adapter 124 fittingly engages with the nozzle 126 which emits the spray, liquid stream, and/or mist therefrom. The handle portion 114 comprises a blower 128 configured to generate airflow to drive air and fluid through the nozzle. A power supply 130 is in electrical communication with the blower 128 to provide power to the system during operation.

In some embodiments, an ON/OFF valve is provided in fluid communication with the supply line 106 to permit the user to start or stop the flow of liquid therethrough. In one example, the ON/OFF valve is provided at the quick disconnect 110. In some embodiments, each ON/OFF valve is provided with one or more hook-and-loop straps and a hose attachment. Once in a suitable position, the hook-and-loop straps are tightened to hold the assembly in place during use. A hose clamp may be provided to ensure the hose attachment and hose interface is hermetically sealed to prevent the expulsion of air and/or fluid therefrom when under operating pressure.

In some embodiments, the reservoir 102 is configured as a backpack having at least two shoulder straps to allow the user to carry the reservoir 102 on their back. A quick-connect harness may be used to attach the sprayer 104 to the reservoir 102. In one example, the quick-connect harness is provided with a hook-and-loop strap to attach the quick-connect harness to the handle portion of the sprayer 104. The clamp is tightened to the backpack strap at a convenient location.

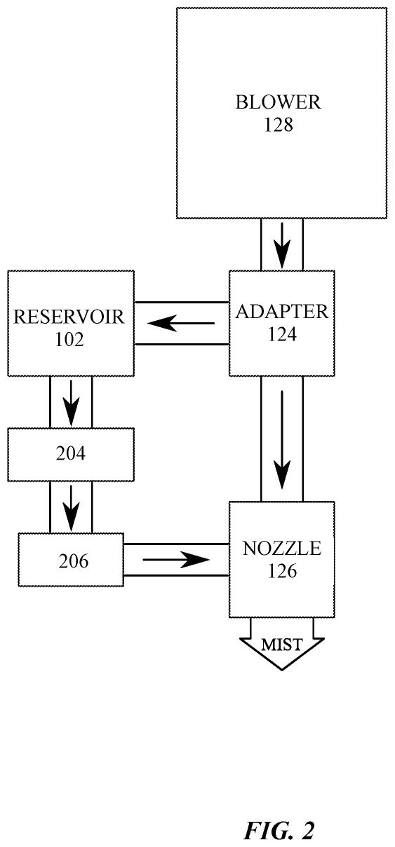

FIG. 2 illustrates a schematic of the blower 128 in fluid communication with the nozzle adapter 124 to connect the nozzle 126 of the sprayer 104. The nozzle 126 may be interchangeable to cause varying types of mist or spray to expelled therefrom. The nozzle adapter 124 transmits the liquid to a fluid reservoir 102 in fluid communication with an attachment 204 and valve 206. The reservoir 206 may retain a pesticide, disinfectant, or other active ingredients, which are mixed with the air to create the mist. In some embodiments, the valve 206 may operate as a flow rate adjuster 112 (see FIG. 1) and/or an ON/OFF valve.

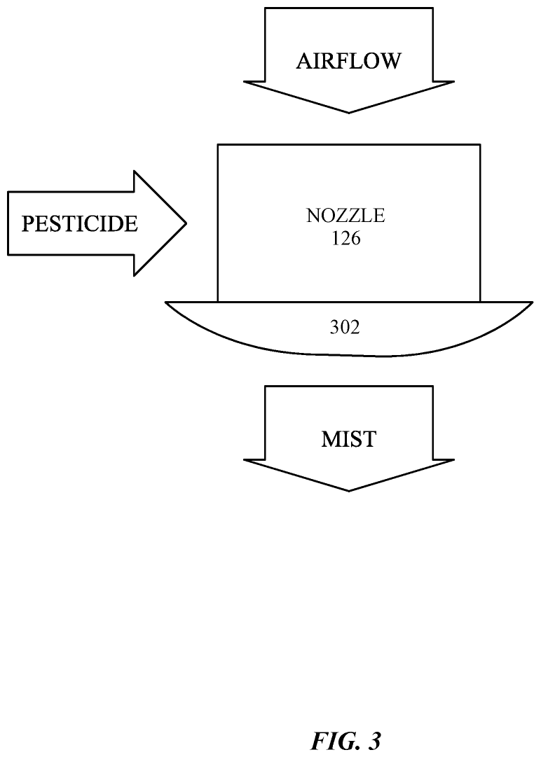

FIG. 3 illustrates a schematic of the system wherein airflow is driven through the nozzle 126 to an atomizer 302, which forms the mist expelled therefrom. The atomizer 302 and/or the nozzle 126 may be interchangeable to allow the user to select various forms of spray, mist, or a stream of liquid. The system 100 includes various interchangeable components, which allow the user to modulate the configuration for various applications including pesticide spraying, indoor disinfectant spraying, etc. Each component is readily interchangeable into the system 100 while maintaining portability.

In some embodiments, the at least one valve is in fluid connection in between the quick-connect attachment and the adjustable nozzle. The at least one valve can comprise a handle which facilitates the opening or closing of the valve and can also be utilized to operate the present invention. Further, as can be seen in FIG. 1-3, the adjustable nozzle is connected to the second adapter end. In the preferred embodiment, the adjustable nozzle comprises a nozzle body, a first nozzle end, a second nozzle end, and an atomizer. The nozzle body comprises a tubular structure with a shape and size matching the shape and size of the adapter body. The first nozzle end is provided opposite to the second nozzle end about the nozzle.

In some embodiments, first nozzle end comprises a space that collects the airflow from the blower as well as the outflow of fluid from the reservoir. The airflow from the blower forces the outflow of the fluid from the reservoir through the atomizer. The atomizer is integrated into the second nozzle end and can be designed to be adjusted so the user can regulate the outflow of the resulting atomized fluid. In alternate embodiments, the adjustable nozzle can be modified to dispense the liquid from the container in a different form.

In some embodiments, the airflow from the air scoop is guided to the reservoir to generate a positive pressure. This forces the fluid within the reservoir out of the reservoir through an outlet of the reservoir. The outlet of the reservoir is connected to conduit, which guides the outflow of the fluid from the reservoir to the adjustable nozzle. In the preferred embodiment, the adjustable nozzle is in fluid connection to the tubing by the quick-connect attachment. The quick-connect attachment is designed to fit most tubing and tubing adapters provided with most backpack pesticide sprayers so the user can quickly couple/decouple the adjustable nozzle from the reservoir. Further, at least one valve is provided for the user to regulate the flow of fluid from the reservoir to the adjustable nozzle.

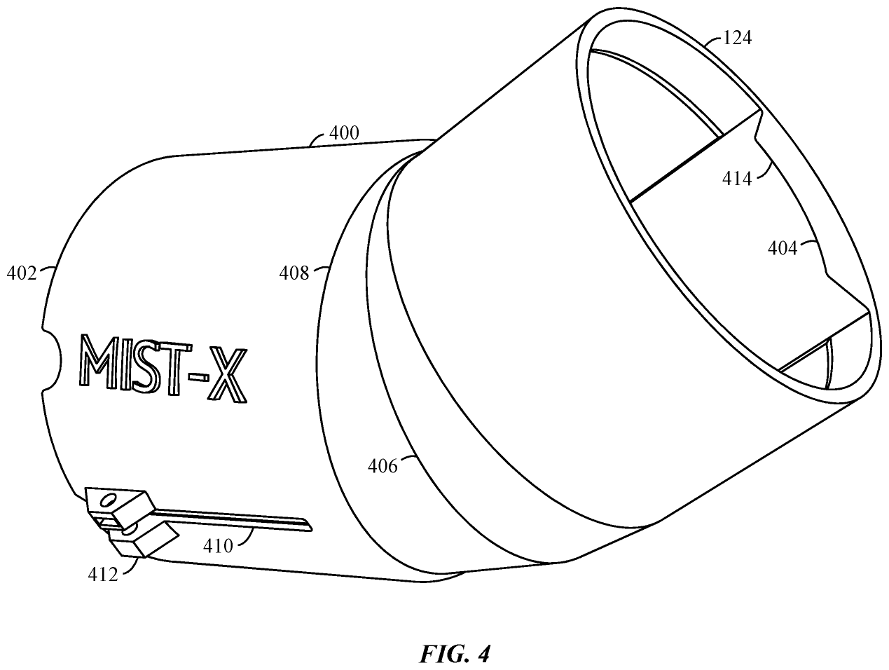

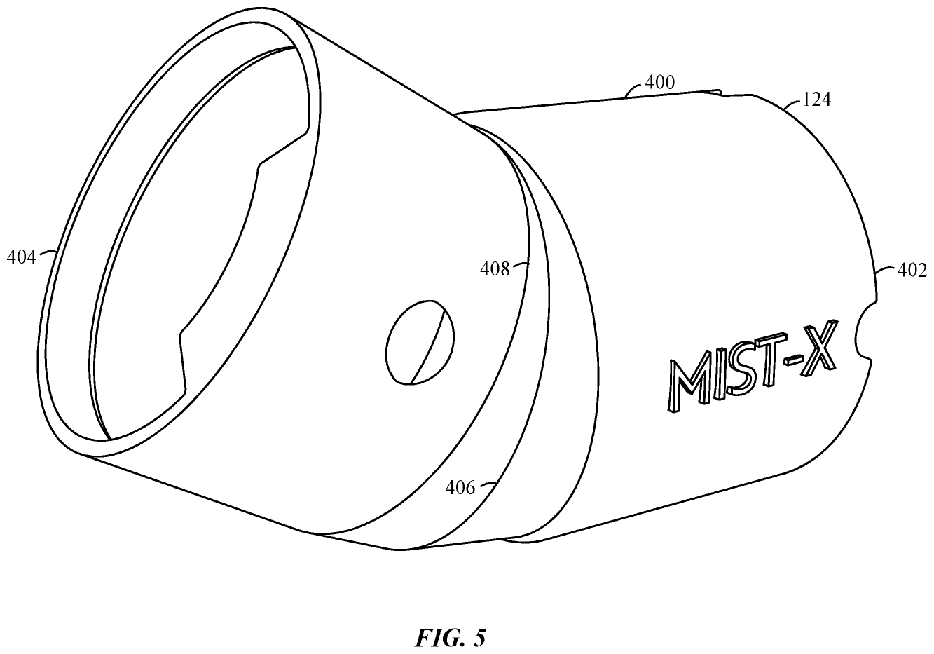

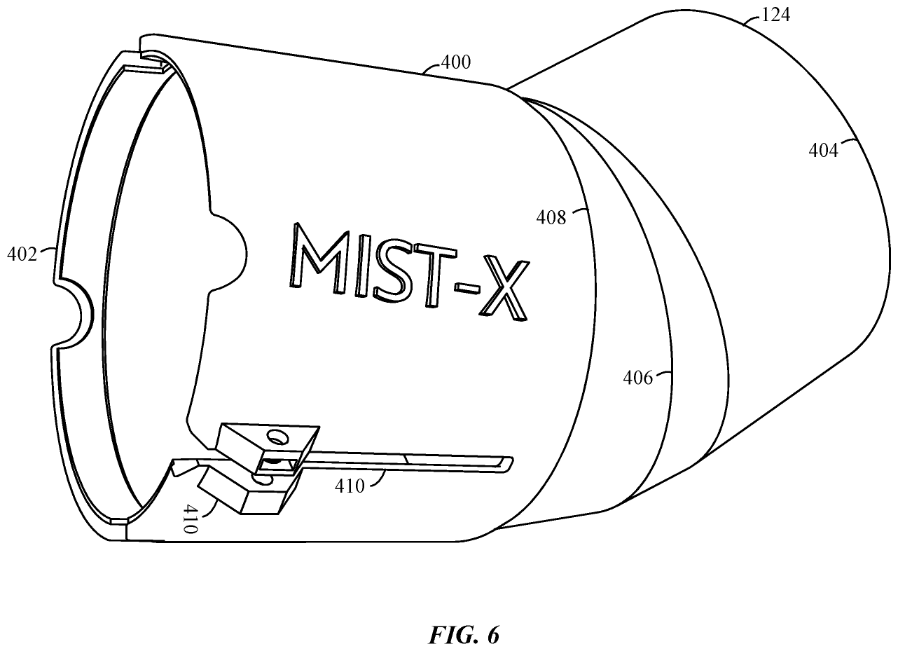

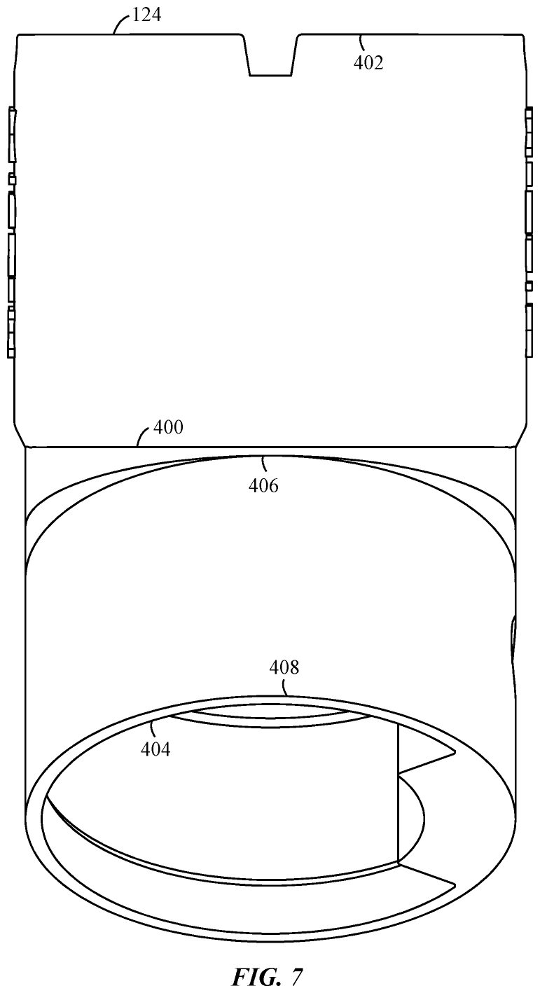

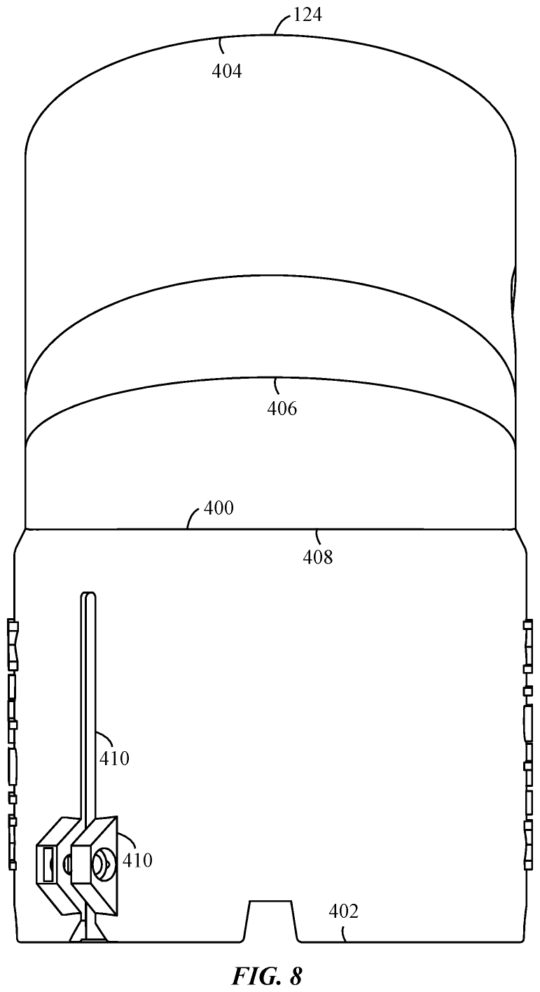

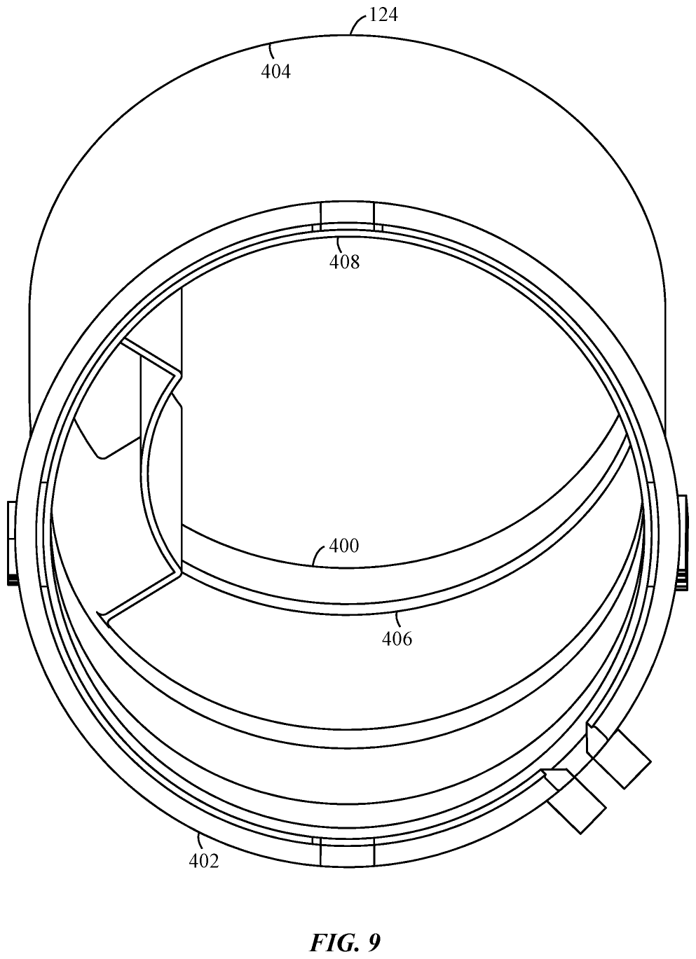

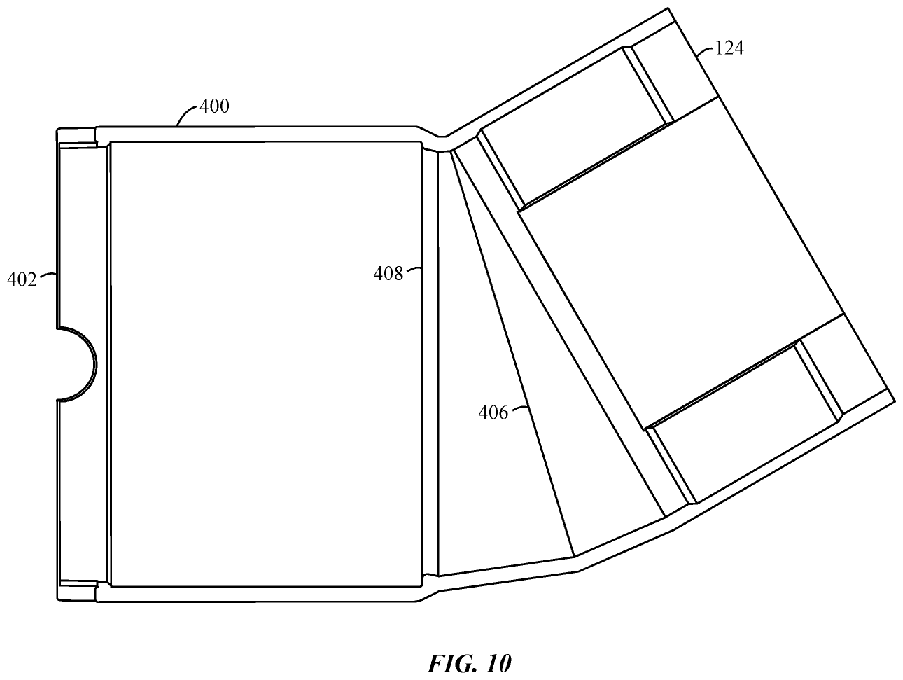

FIGS. 4-10 illustrate the nozzle adapter 124 which comprises tubing 400 forming a hollow tubular design that is bent about halfway at a predetermined angle. The nozzle adapter 124 is comprised of a first adapter end 402 provided opposite to the second adapter end 404. A bend 406 may be provided along the length of the adapter body 408. The first adapter end 402 fits onto the opening of the sprayer 104 (shown in FIG. 1). The second adapter end 404 receives the adjustable nozzle (shown in FIG. 1). The first adapter end 402 comprises a receiver 410 configured as a channel to permit attachment to the opening of the sprayer 104. The receiver 410 may include a locking mechanism 412 that secures the adapter body to the outlet of the blower. The locking mechanism 412 is preferably integrated into the first adapter end and adjustable to match the size of the outlet of the blower.

In some embodiments, the air scoop 414 (see FIG. 4) is integrated within the adapter body 408 adjacent to the second adapter end 404. The air scoop may be used with a manually powered backpack sprayer.

In some embodiments, the air scoop is designed to reroute airflow coming out from the blower, through the adapter body, and out of the air scoop to be guided to the reservoir of a backpack pesticide sprayer. The air scoop preferably comprises a scoop body and at least one orifice. The scoop body is designed to guide a portion of the airflow out of the at least one orifice. The at least one orifice is integrated into the adapter body, adjacent to the scoop body, and comprises a size and shape matching the optional positive-pressure line. In alternate embodiments, the nozzle adapter comprises a different structure that can be attached to a different device.

In some embodiments, the nozzle adapter is replaceable and may be provided as a set or kit of nozzle adapters having various angles of the bend. In such, the user may select an appropriate nozzle adapter for the application. Further, the nozzle adapter may include an embodiment without a bend.

The system is designed to be quickly deployed as well as to be quickly stored. The user first disconnects the existing sprayer from the backpack reservoir. The hose equipped with the quick-connect attachment is then attached to the reservoir. The nozzle adapter is attached to the outlet of the blower, and the adjustable nozzle is connected to the nozzle adapter. The user then adjusts the orientation of the nozzle adapter to the direction the user wants to dispense pesticide. Utilizing the quick-connect harness, the user tethers the present invention to a strap of the backpack pesticide sprayer. The quick connect harness frees up the hands of the user while operating the present invention. Then, using the handle of at least one valve and turning on the blower, the user can direct the atomized pesticide to the desired area. The user can turn the adjustable nozzle to control the atomization/mist level.

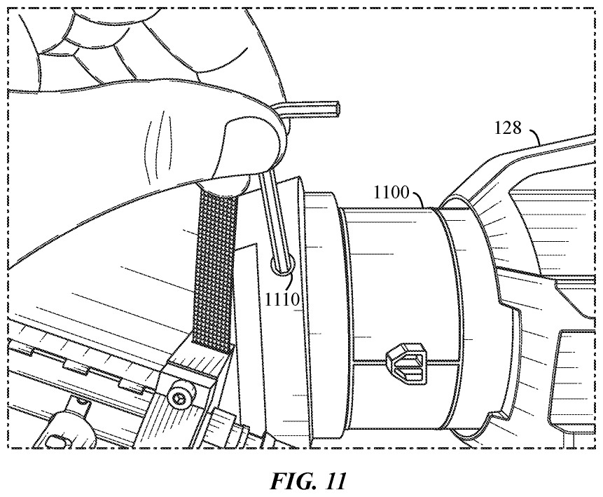

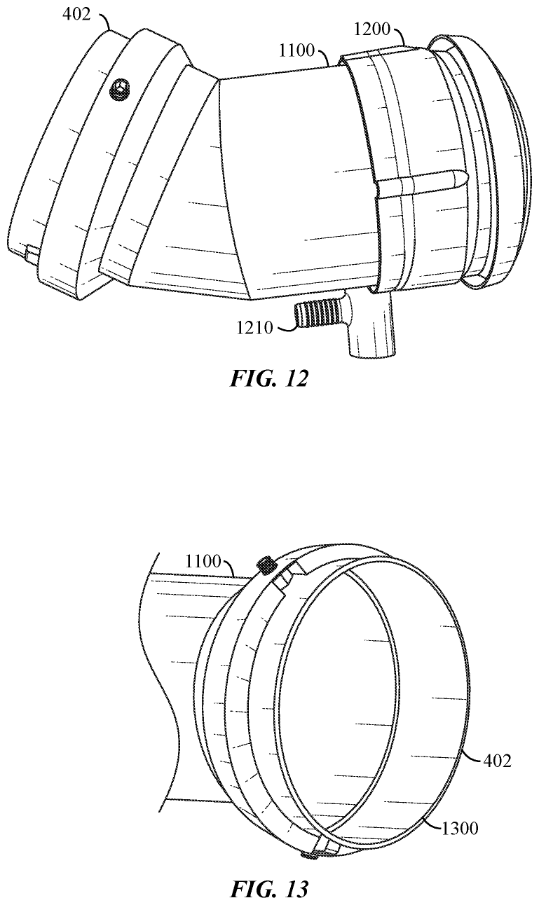

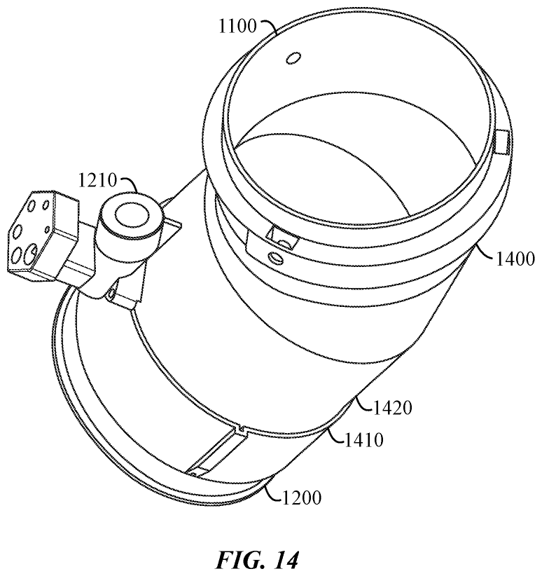

FIG. 11 illustrates the adapter system 1100 used for transforming an electric backpack and blower into a sprayer. As illustrated in FIG. 11, the blower 128 is engaged with the adapter system via an attachment mechanism 1110 allowing the user to selectively attach and remove the adapter system 1100. FIG. 12 illustrates the adapter system 1100 attached to the nozzle fixture 1200 which is a permanent fixture to the adapter system 1100. The nozzle fixture 1200 is positioned on the opposite end from the first adapter end 402. The positive pressure input port 1210 may be an optional component utilized for the manual (non-electric) backpack sprayer systems. Similarly, FIG. 13 illustrates the first adapter end 402 of the adapter system for transforming an electric backpack and blower into a sprayer. The receiving portion 1300 will receive the blower to form an airtight seal therebetween.

FIG. 14 illustrates a perspective view of the adapter system 1100, having a nozzle 1200 and collar 1410 configured to fit around a circumference 1420 of the adapter system 110. A bent portion 1400 is provided along the length of the adapter system 1100 to orient the nozzle 1200 in a desirable position. In some embodiments, the bent portion 1400 may be adjustable by the user to modify the orientation of the nozzle 1200 for various applications of the system. An embodiment of the positive pressure input port 1210 around the circumference 1420 of the adapter system 1100. One skilled in the arts will readily understand that the aesthetic features of the adapter system 1100 may be modified to accommodate various blower, sprayer, and nozzle configurations such that the adapter system 1100 may be utilized for transforming an electric backpack and blower into a sprayer.

Many different embodiments have been disclosed herein, in connection with the above description and the drawings. It will be understood that it would be unduly repetitious and obfuscating to describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

It will be appreciated by persons skilled in the art that the present embodiment is not limited to what has been particularly shown and described hereinabove. A variety of modifications and variations are possible in light of the above teachings without departing from the following claims.

What is claimed is:

1. An adapter system for a sprayer, the adapter system comprising:
a reservoir in fluid communication with a sprayer, the reservoir to retain a liquid;
one or more supply lines to deliver the liquid to the sprayer, the sprayer comprising a blower having a handle portion including a first side to receive a conduit in fluid communication with a nozzle adapter and a nozzle to emit a mist therefrom; and
a power supply in electrical communication with the blower to supply power thereto.

2. The adapter system of claim 1, wherein the nozzle adapter is releasably engaged with the handle portion via a conduit.

3. The adapter system of claim 2, wherein the nozzle adapter comprises a first adapter end fittingly engaged with the conduit and a second adapter end fittingly engaged with the nozzle, and wherein the nozzle adapter includes a receiver having a channel to attach to the conduit.

4. The adapter system of claim 3, wherein the receiver is comprised of a locking mechanism to secure the receiver to the conduit.

5. The adapter system of claim 4, wherein the reservoir is configured as a backpack having at least two shoulder straps.

6. The adapter system of claim 5, wherein a bend is positioned along the length of the nozzle adapter.

7. The adapter system of claim 6, further comprising an ON/OFF valve positioned in fluid communication with the supply line.

8. The adapter system of claim 7, wherein the supply line comprises a quick disconnect coupler to attach the supply line to the nozzle adapter.

9. An adapter system for transforming an electric backpack and blower into a sprayer, the assembly comprising:
a reservoir in fluid communication with a sprayer, the reservoir to retain a liquid;
one or more supply lines releasably engaged to a nozzle adapter via a quick disconnect coupler, the one or more supply lines to deliver the liquid to the sprayer, the sprayer comprising a blower having a handle portion including a first side to receive a conduit in fluid communication with the nozzle adapter and a nozzle having an atomizer to emit a mist therefrom; and
a power supply in electrical communication with the blower to supply power thereto.

10. The adapter system of claim 9, wherein the nozzle adapter is releasably engaged with the handle portion via a conduit.

11. The adapter system of claim 10, wherein the nozzle adapter comprises a first adapter end fittingly engaged with the conduit and a second adapter end fittingly engaged with the nozzle, and wherein the nozzle adapter includes a receiver having a channel to attach to the conduit.

12. The adapter system of claim 11, wherein the receiver is comprised of a locking mechanism to secure the receiver to the conduit.

13. The adapter system of claim 12, wherein the reservoir is configured as a backpack having at least two shoulder straps.

14. The adapter system of claim 13, wherein a bend is positioned along the length of the nozzle adapter.

15. The adapter system of claim 14, further comprising an ON/OFF valve positioned in fluid communication with the supply line.

16. The adapter system of claim 15, wherein the supply line comprises a quick disconnect coupler to attach the supply line to the nozzle adapter.

17. The adapter system of claim 16, wherein the handle portion releasably engages with a quick-connect harness.

18. The adapter system of claim 17, further comprising a positive pressure line in fluid communication with the reservoir and the blower to provide positive pressure to the reservoir to force fluid through the supply line.

19. The adapter system of claim 18, further comprising an air scoop positioned in the interior of the nozzle adapter to generate positive pressure therein.

20. An adapter system for transforming an electric backpack into a sprayer, the assembly comprising:
a reservoir to retain a liquid pesticide or a liquid disinfectant in fluid communication with a sprayer, the reservoir to retain a liquid;
one or more supply lines releasably engaged to a nozzle adapter via a quick disconnect coupler, the one or more supply lines to deliver the liquid to the sprayer the supply line secured to the sprayer via at least one hook-and-loop strap and at least one clamp, the sprayer comprising a blower having a handle portion including a first side to receive a conduit in fluid communication with the nozzle adapter and a nozzle having an atomizer to emit a mist therefrom, wherein the nozzle adapter comprises a receiver to releasably engage with the conduit; and
a power supply in electrical communication with the blower to supply power thereto.
